(19) United States
(12) Patent Application Publication
(10) Pub. No.: US 2025/0325993 A1
(43) Pub. Date: Oct. 23, 2025

(54) SPRAY NOZZLE ASSEMBLY WITH MULTIPLE DISCHARGE ORIFICES AND INDEPENDENT FLOW CONTROL

(71) Applicant: Spraying Systems Co., Wheaton, IL (US)

(72) Inventor: Daniel Vidusek, Hampshire, IL (US)

(21) Appl. No.: 19/098,651

(22) Filed: Apr. 2, 2025

Related U.S. Application Data
(60) Provisional application No. 63/637,739, filed on Apr. 23, 2024.

(51) Int. Cl. B05B 1/20

(52) U.S. Cl. CPC B05B 1/20

(57) ABSTRACT

A spray nozzle assembly includes a nozzle body supporting a plurality of spray nozzles. The plurality of spray nozzles are divided into a plurality of different stages. The nozzle body includes a first fluid distribution passage that communicates with a first spray nozzle stage and a second fluid distribution passage that communicates with a second spray nozzle stage. A nozzle inlet includes a plurality of fluid inlets including a first fluid inlet that communicates with the first fluid distribution passage of the nozzle body and a second fluid inlet that communicates with the second fluid distribution passage of the nozzle body. Control of fluid flow through the first fluid distribution passage to the first spray nozzle stage and through the second fluid distribution passage to the second spray nozzle stage adjusts a total spray volume or a flow rate of the spray nozzle assembly.

### BACKGROUND OF THE INVENTION

Gas fired turbines typically draw an air stream through a series of compressor stages that compress the air. The compressed air is directed into a combustion chamber and heated, and the rapidly expanding heated gases drive turbine blades that generate power. To enhance output power, it is known to spray fine water particles into the inlet air stream that cools the air to increase its density, and hence, enables increased subsequent gas expansion for driving the turbine blades.

Additionally, it is known to use fluid spray nozzles to discharge water droplets into the compressor stage of the turbine in order to further increase the electrical output of the turbine. Two-fluid nozzles discharging compressed air and water have historically been used to spray into the compressor stage of the turbine for turbine power augmentation. The spray nozzles are typically installed on the side of the turbine at the compressor stage, such that the spray pattern from the nozzle is injected perpendicular to the air stream inside the turbine. Using compressed air in a spray nozzle, sometimes referred to as an air atomizing spray nozzle, provides the benefit of additional water droplet breakup compared to hydraulic only nozzles. However, there are certain limitations as to how small a droplet can be generated from a single air-atomizing nozzle. In turbine applications, it is desirable to make as small a droplet as possible as turbine blade wear can be attributed to droplets that are relatively large or have not quite evaporated before impacting the turbine blades.

Additionally, a turbine may operate under different load conditions based on the electrical demand placed on the turbine. In order to optimize the electricity production of the turbine, it may be desirable to adjust the flow rate of the spray nozzles discharging water droplets into the compressor stage to operate at different flow rates. However, adjusting the flow rate of individual nozzles necessarily requires an adjustment in the pressure of the water provided to the nozzles. This variance in pressure can lead to operational issues with turbine compressor spraying systems as well as with spraying systems in other fluid injection applications.

### OBJECTS OF THE INVENTION

In view of the foregoing, a general object of the present invention is to provide a spray nozzle assembly with hydraulic atomization that is capable of producing a consistently small droplet size.

Another object of the present invention is to provide a spray nozzle assembly with which the total flow output of the spray nozzle assembly can be easily and accurately adjusted to accommodate variable flow requirements of a particular application.

A further object of the present invention is to provide a spray nozzle assembly of the foregoing type that can be configured for applications involving injecting liquids into flowing fluids.

Other objects and advantages of the invention will become apparent upon reading the following detailed description and upon reference to the drawings. The identified objects are not intended to limit the present invention.

### BRIEF DESCRIPTION OF THE SEVERAL VIEWS OF THE DRAWINGS

FIG. 1 is a top perspective view of an exemplary embodiment of a spray nozzle assembly according to the present invention.

FIG. 2 is a side elevation view of the spray nozzle assembly of FIG. 1.

FIG. 3 is a top view of the spray nozzle assembly of FIG. 1.

FIG. 4 is an end view of the spray nozzle assembly of FIG. 1.

FIG. 5 is a cross-section of the spray nozzle assembly of FIG. 1 taken in the plane of line 5-5 of FIG. 4.

FIG. 6 is a top view of the injector body of the spray nozzle assembly of FIG. 1.

FIG. 7 is an end view of the injector body of FIG. 6.

FIG. 8 is a cross-section of the injector body of FIG. 6 taken in the plane of line 8-8 of FIG. 6.

FIG. 9 is a cross-section of the injector body of FIG. 6 taken in the plane of line 9-9 of FIG. 7.

FIG. 10 is a top view of the nozzle insert of the spray nozzle assembly of FIG. 1.

FIG. 11 is a side elevation view of the nozzle insert of FIG. 10.

FIG. 12 is a side view of the body adaptor and center tube assembly of the spray nozzle assembly of FIG. 1.

FIG. 13 is a cross-section of the body adaptor and center tube assembly of FIG. 12 taken in the plane of line 13-13 of FIG. 12.

### DETAILED DESCRIPTION OF THE INVENTION

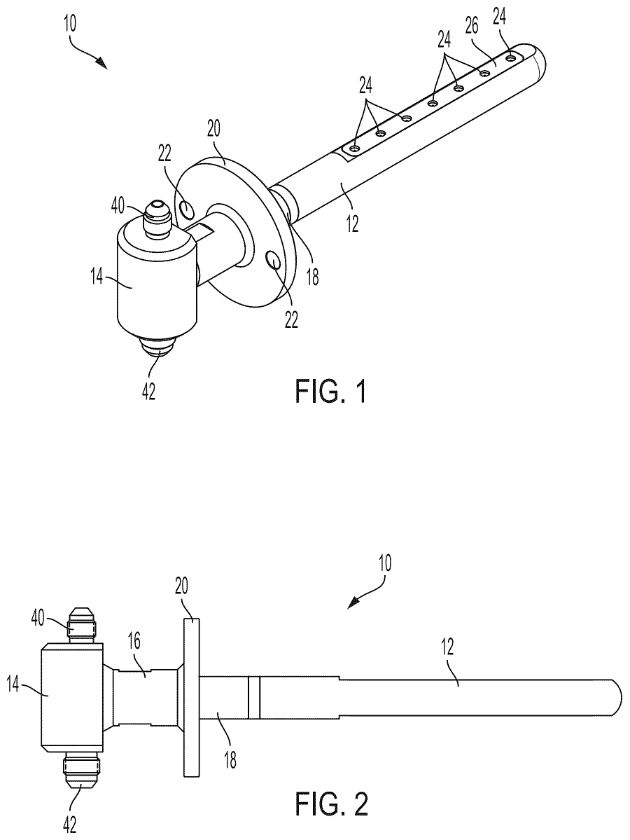

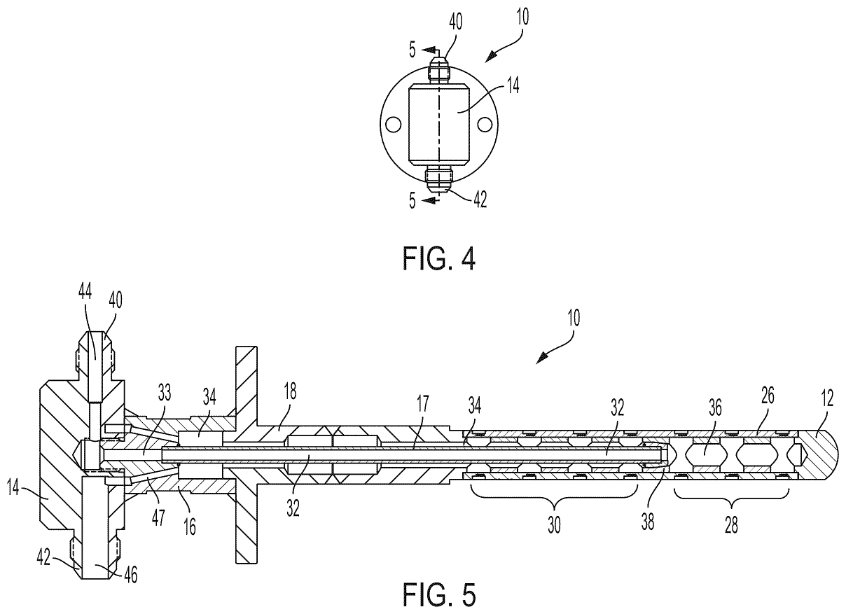

Referring to FIGS. 1-4 of the drawings, there is shown an exemplary embodiment of a spray nozzle assembly 10 according to the present invention. The spray nozzle assembly 10 of FIGS. 1-4 is specifically configured for use in injecting fluid into a fluid medium, which may be the same or a different from the fluid being sprayed. One such application is the spraying of water into the compressor stage of a gas turbine. The fluid being injected by the spray nozzle assembly 10 may be the same as, or different than, the fluid medium. However, the spray nozzle assembly 10 of the present invention is not limited to discharging water in gas turbine applications. To the contrary, the spray nozzle assembly 10 could be used in a variety of different fluid injection applications to discharge a variety of different fluids. For example, the spray nozzle assembly 10 could be used for injecting corrosion resistance or anti-freeze chemicals into pipelines in the oil and gas industry.

In the illustrated embodiment, the spray nozzle assembly 10 is generally configured as an injector. However, in other embodiments, depending on the particular application in which it will be used, the spray nozzle assembly 10 could have other configurations, such as for example a manifold. The spray nozzle assembly 10 includes a downstream nozzle body that in this case is configured as an injector body 12 that has an elongated tubular configuration and an upstream inlet portion 14. As used herein, in normal operation of the spray nozzle assembly 10, fluid flows from the upstream direction and towards the downstream direction, i.e., from upstream to downstream. In this case, the spray nozzle assembly 10 further includes a body adaptor 16 and a flange 18 between the inlet portion 14 and the injector body 12 with the body adaptor 16 being immediately downstream of the inlet portion 14 and the flange 18 being immediately upstream of the injector body 12. While the body adaptor 16 and flange 18 are separate components that are connected together (e.g., by welding) in the illustrated embodiment, they could be combined into a single piece in other embodiments. As described in detail below, in the illustrated embodiment, the body adaptor 16 (together with a center tube 17 supported by the body adaptor 16) and flange 18 help define the fluid distribution passages that carry fluid from the inlet portion 14 to the injector body 12. In this case, the flange 18 also serves a mounting bracket for the spray nozzle assembly 10. In particular, the illustrated flange 18 includes a radially outwardly extending mounting bracket portion 20 that includes mounting holes 22 (see FIG. 1), which can be used to secure the spray nozzle assembly 10 to a housing or the like, such as a turbine compressor housing. The size and configuration of the mounting bracket portion 20 may vary depending on the mounting requirements for a particular application.

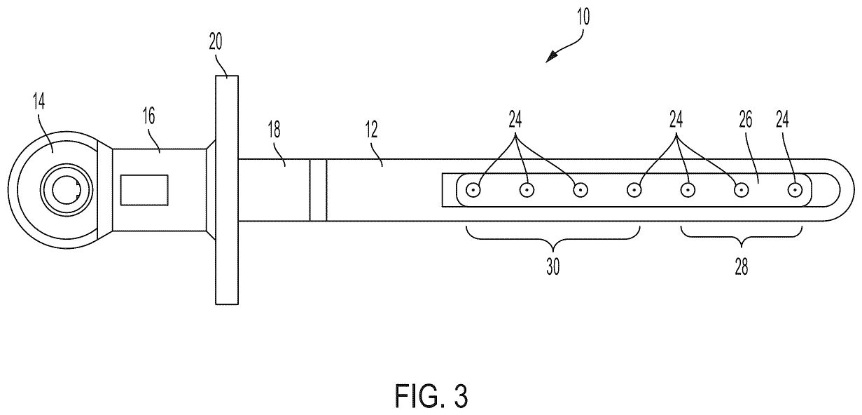

For discharging fluid, the injector body 12 supports a plurality of spray nozzles 24 (see FIGS. 1 and 3). In a known manner, each of the spray nozzles 24 may include a respective discharge orifice 25 through which fluid may be discharged. Each of the spray nozzles 24, in this case, is configured to provide hydraulic atomization of the discharging fluid. In gas turbine applications, the air stream inside the turbine could have a velocity of about 200 mph, which could provide additional shearing of the droplets that exit from the spray nozzles 24. In the illustrated embodiment, a plurality of spray nozzles 24 are provided on each of two opposing sides of the injector body 12 (the other side being opposite the side shown in FIGS. 1 and 3) with the spray nozzles 24 at uniformly spaced intervals laterally along the injector body 12. The number and orientation of the individual spray nozzles 24 may vary depending on, for example, the requirements of the particular application in which the spray nozzle assembly 10 is to be used. The number and orientation of the spray nozzles may also vary based on the orientation at which the spray nozzle assembly 10 is mounted. For example, according to some embodiments including gas turbine compressors, the spray nozzle assembly 10 and individual spray nozzles 24 may be arranged to discharge fluid in a direction substantially perpendicular to the flow of the medium (e.g., air stream or flow of liquid) into which the nozzles are discharging.

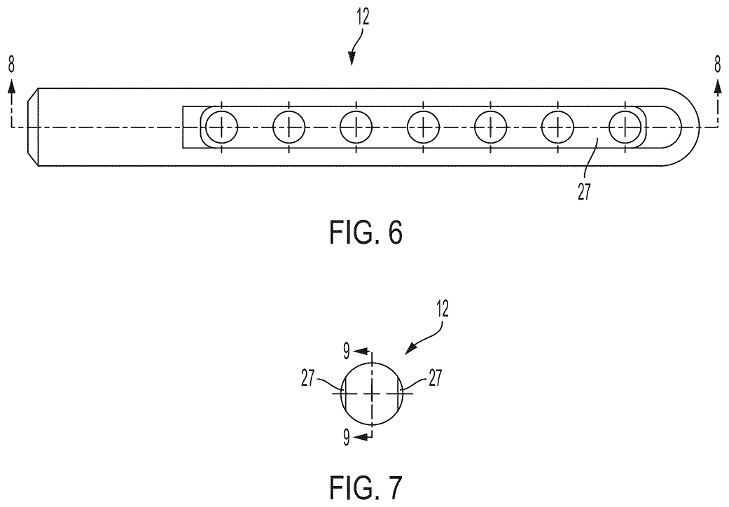

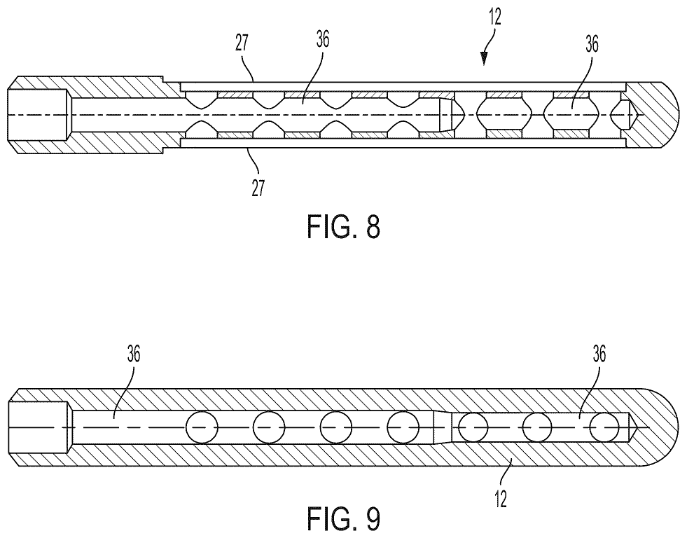

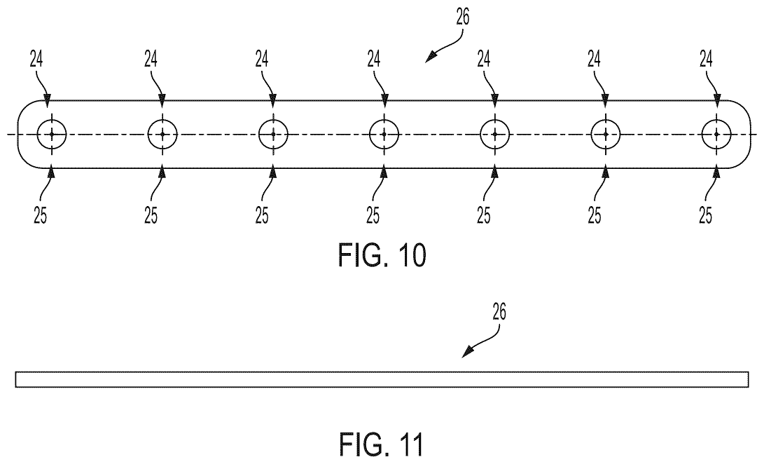

To provide the spray nozzle assembly 10 with a low lateral profile that allows for usage in applications with tight spacing requirements, the individual spray nozzles 24 may be formed as inserts 26 that are, in this instance, attached to mounting locations 25 on the sides of the injector body 12 as shown in the cross-section of FIG. 5. The mounting locations can be seen in FIGS. 6 and 7 which show the injector body 12 without the inserts 26 attached. Each insert 26 may be in the form of a laminated strip that contains multiple individual spray nozzles 24 as shown in FIGS. 10-11. In the illustrated embodiment, two such laminated strip-like inserts 26 are provided on the mounting locations 25 on opposing sides of the external sidewall of the injector body 12 with each laminated insert 26 containing seven spray nozzles 24. These laminated inserts 26 are formed by etching the individual spray nozzle discharge passages onto thin metal sheets. The etched metal sheets are then bonded together, creating monolithic laminated nozzles. These laminated nozzles have a low vertical profile as compared to spray nozzles made by traditional milling, drilling, and turning of metal bar stock to create the flow passages. This low profile allows the spray nozzle assembly 10 to fit into applications, such as gas turbine compressors, featuring tight spaces. As will be appreciated, in other embodiments, the individual nozzles 24 may have configurations that are more conventional. In addition, the individual spray nozzles 24 may be configured to produce any desired spray pattern. For example, spray nozzles 24 that produce a fog-like pattern with fine droplets is preferable for turbine compressor applications. In other embodiments, the individual spray nozzles 24 may produce different spray patterns and/or have different flow capacities.

To allow for variation in the spray volume or flow rate produced by the spray nozzle assembly 10, the plurality of spray nozzles 24 may be organized into two or more stages each of which includes a group of one or more of the spray nozzles 24 provided on the injector body 12. It can be advantageous in some situations if at least some of the stages have a different number of spray nozzles than the other stages. Further, each stage of the spray nozzle assembly 10 may have an independent fluid distribution passage, which directs fluid to the respective grouping of spray nozzles 24 associated with that stage. For example, in the illustrated embodiment, a first stage 28 consists of a grouping of six spray nozzles 24 and a second stage 30 consists of a grouping of eight spray nozzles (see FIGS. 3 and 5). Further, the spray nozzle assembly 10 includes a first fluid distribution passage 32 that directs fluid to the first stage 28 of spray nozzles and a second fluid distribution passage 34 that directs fluid to the second stage 30 of spray nozzles (see FIG. 5).

By turning off or on the flow of fluid through the first and second fluid distribution passages 32, 34, the total spray volume or flow rate produced by the spray nozzle assembly 10 may be adjusted. In this case, by turning on the flow of fluid in the first fluid distribution passage 32 and turning off the flow of fluid in the second fluid distribution passage 34 results in fluid being discharged from six of the fourteen spray nozzles 24 of the spray nozzle assembly 10. Conversely, if the flow of fluid in the second fluid distribution passage 34 is turned on and the flow of fluid in the second fluid distribution passage 34 is turned off, fluid will be discharged from eight of the fourteen spray nozzles 24 of the spray nozzle assembly 10. If the flow of fluid in both the first and second fluid distribution passages 32, 34 is turned on, fluid will be discharged from all fourteen of the spray nozzles 24. Thus, by turning off and on the flow of fluid through the first and second fluid distribution passages 32, 34, the spray nozzle assembly 10 may be operated at approximately 43%, approximately 57% or 100% of the flow capacity of the spray nozzle assembly 10. Advantageously, this change in flow rates can be accomplished without a significant change in the pressure of the fluid supplied to the spray nozzle assembly 10. This ability to quickly and easily adjust the total flow rate produced by the spray nozzle assembly 10 significantly increases the versatility of the spray nozzle assembly. For example, in a turbine compressor application, the deionized water output of the spray nozzle assembly 10 may be adjusted to match the particular load conditions of the turbine based on the existing electricity demand. As will be appreciated, the number of stages and the number of spray nozzles in each individual stage can vary depending on the needs of a particular application for more or less adjustability in flow.

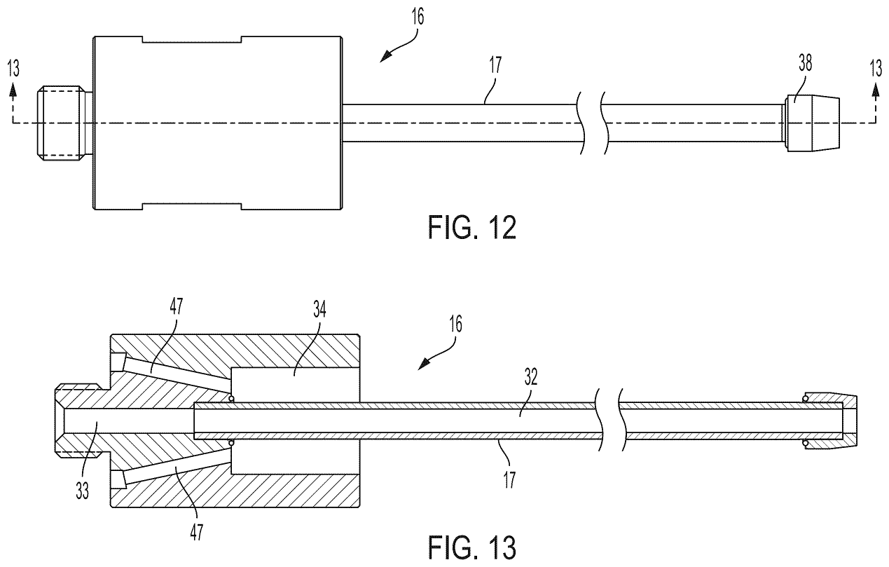

In the illustrated embodiment, the first fluid distribution passage 32 that feeds the first stage 28 of fluid nozzles comprises a passage defined, at least in part, by the center tube 17 that extends in the longitudinal direction generally in the center of the spray nozzle assembly 10. The center tube 17 may be supported as part of an assembly with the body adaptor 16 (as shown in FIGS. 12 and 13) with the center tube 17 being received in an internal bore 36 of the injector body 12 when the spray nozzle assembly is assembled. In particular, as shown in FIG. 5, the first fluid distribution passage 32 begins at an upstream end in a first passage section 33 in the body adaptor 16 that communicates with the center tube 17 (as also shown in FIG. 13) and terminates at a downstream end in the injector body 12. At its downstream end, the first fluid distribution passage 32 communicates with the downstream internal bore 36 of the injector body 12. The downstream internal bore 36 of the injector body 12, in turn, communicates with, the first stage 28 of spray nozzles, which in this case are the six farthest downstream spray nozzles 24 (three on each side of the injector body, see FIG. 5).

In the illustrated embodiment, the second fluid distribution passage 34 comprises a generally annular passage that extends in surrounding relation to, and outward of, the center tube 17 that defines the first fluid distribution passage 32 as shown in FIG. 5. In this case, the second fluid distribution passage 34 is defined by the external surface of the center tube 17 and the internal bore 36 of the injector body 12. Like the first fluid distribution passage 32, the second fluid distribution passage 34 begins at an upstream end in the in the body adaptor 16, extends through the flange 18 and ends at a downstream end in the injector body 12. A barrier 38 (see FIG. 5) is provided at the downstream end of the second fluid distribution passage 34. The downstream end of the center tube 17 includes a seat 37 (see FIGS. 12 and 13) that when inserted in the internal bore 36 of the injector body 12 defines a barrier 38 that extends between the external surface of the center tube 17 and the inside wall of the internal bore 36 of the injector body 12. This barrier 38 isolates the second fluid distribution passage 34 from the downstream internal bore 36 of the injector body 12 that communicates with the first fluid distribution passage 32 of the center tube 17, thus isolating the second fluid distribution passage 34 from the first stage 28 of spray nozzles. The portion of the second fluid distribution passage 34 in the injector body 12 communicates with the second stage 30 of spray nozzles. In this case, the second stage 30 spray nozzles comprise the six spray nozzles 24 that are farthest upstream on the injector body (see FIG. 5). As will be appreciated, the fluid distribution passages may have different configurations in other embodiments of the spray nozzle assembly 10. Moreover, the spray nozzle stages may have different locations in other embodiments of the spray nozzle assembly 10.

To enable the spray nozzle assembly 10 to be connected to multiple fluid supply lines, the inlet portion 14 may be configured to define multiple, distinct fluid inlets. Each of these fluid inlets may communicate with a respective one of the fluid distribution passages that direct fluid to the different stages of the spray nozzle assembly. In this case, the inlet portion 14 of the spray nozzle assembly 10 has a T-shaped configuration (see FIGS. 1 and 2) with first and second fluid inlets 40, 42. As shown in FIG. 5, the first and second fluid inlets 40, 42 include respective first and second fluid inlet passageways 44, 46 that can communicate with a respective fluid supply line. Moreover, the first fluid inlet passageway 44 further communicates with the first fluid distribution passage 32, while the second fluid inlet passageway 46 further communicates with the second fluid distribution passage 34. In this case, the second fluid inlet passageway 46 communicates with a radially inwardly angled fluid passage 47 in the body adaptor 16 that extends from the inlet portion 14 to the downstream end of the second fluid distribution passage 46. In illustrated embodiment, the fluid inlet passageways 44, 46 extend in a lateral or perpendicular direction with respect to the longitudinal axis of the spray nozzle assembly 10 and the direction of fluid flow through the injector body 12. Each inlet 40, 42 may have an associated valve assembly that is operable to open or close the flow of fluid to and/or through the respective inlet. The valve assembly can be integrated into the inlet portion 14 or provided in the respective fluid supply line. Liquid may be directed by a pump to the fluid inlets 40, 42 through the respective fluid supply line. In some embodiments, such as those being used in gas turbine applications, the fluid can be deionized water. As noted above, in other embodiments, such as those being used in pipelines in the oil and gas industry, the fluid may be corrosion resistance or anti-freeze chemicals.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A spray nozzle assembly comprising:
a nozzle body supporting a plurality of spray nozzles, the plurality of spray nozzles being divided into a plurality of different stages with each stage including a distinct set of one or more of the plurality of spray nozzles, wherein the nozzle body includes a first fluid distribution passage that communicates with a first spray nozzle stage of the plurality of stages and a second fluid distribution passage that communicates with a second spray nozzle stage of the plurality of stages; and
a nozzle inlet including a plurality of fluid inlets each of the fluid inlets being connectable to a fluid supply, the plurality of fluid inlets including a first fluid inlet that communicates with the first fluid distribution passage of the nozzle body and a second fluid inlet that communicates with the second fluid distribution passage of the nozzle body;
wherein control of fluid flow through the first fluid distribution passage to the first spray nozzle stage and through the second fluid distribution passage to the second spray nozzle stage adjusts a total spray volume or a flow rate of the spray nozzle assembly.

2. The spray nozzle assembly of claim 1, wherein the nozzle body is configured as an injector with an elongated tubular configuration.

3. The spray nozzle assembly of claim 1, wherein the plurality of spray nozzles are formed in at least one laminated strip that is supported on an external sidewall of the nozzle body.

4. The spray nozzle assembly of claim 3, wherein a separate discharge passage for each spray nozzle is etched in a thin sheet with the thin sheets being bonded together to form the laminated of spray nozzles.

5. The spray nozzle assembly of claim 1, wherein the first fluid distribution passage comprises a tube that extends in an internal bore of the nozzle body.

6. The spray nozzle assembly of claim 5, wherein the second fluid distribution passage comprises an annular passage that extends in surrounding to relation to the tube and is defined by an external surface of the tube and the internal bore of the nozzle body.

7. The spray nozzle assembly of claim 6, wherein the second fluid distribution passage terminates with a barrier that isolates the second fluid distribution passage from a first portion of the internal bore of the nozzle body downstream of the barrier that communicates with the first spray nozzle stage.

8. The spray nozzle assembly of claim 7, wherein the first fluid distribution passage communicates with the first portion of the internal bore of the nozzle body.

9. The spray nozzle assembly of claim 7, wherein a second portion of the internal bore of the nozzle body upstream of the internal bore communicates with the second spray nozzle stage.

10. The spray nozzle assembly of claim 5, further including a body adaptor arranged between the inlet portion and the nozzle body, the body adaptor supporting the tube and defining a portion of the second fluid distribution passage.

11. The spray nozzle assembly of claim 3, wherein a laminated strip comprising a plurality of spray nozzles is provided on each of two opposing sides of the nozzle body.

12. The spray nozzle assembly of claim 1, wherein the first spray nozzle stage is located at a downstream portion of the nozzle body and the second spray nozzle stage is located upstream of the first spray nozzle stage.

13. A spray nozzle assembly comprising:
a nozzle body supporting a plurality of spray nozzles, the plurality of spray nozzles being divided into a plurality of different stages with each stage including a distinct set of one or more of the plurality of spray nozzles, wherein the nozzle body includes a first fluid distribution passage that communicates with a first spray nozzle stage of the plurality of stages and a second fluid distribution passage that communicates with a second spray nozzle stage of the plurality of stages; and
wherein control of fluid flow through the first fluid distribution passage to the first spray nozzle stage and through the second fluid distribution passage to the second spray nozzle stage adjusts a total spray volume or a flow rate of the spray nozzle assembly.

14. The spray nozzle assembly of claim 13, wherein the nozzle body is configured as an injector with an elongated tubular configuration.

15. The spray nozzle assembly of claim 13, wherein the plurality of spray nozzles are formed in at least one laminated strip that is supported on an external sidewall of the nozzle body.

16. The spray nozzle assembly of claim 13, wherein a separate discharge passage for each spray nozzle is etched in a thin sheet with the thin sheets being bonded together to form the laminated of spray nozzles.

17. The spray nozzle assembly of claim 13, wherein the first fluid distribution passage comprises a tube that extends in an internal bore of the nozzle body.

18. The spray nozzle assembly of claim 17, wherein the second fluid distribution passage comprises an annular passage that extends in surrounding to relation to the tube and is defined by an external surface of the tube and the internal bore of the nozzle body.

19. The spray nozzle assembly of claim 18, wherein the second fluid distribution passage terminates with a barrier that isolates the second fluid distribution passage from a first portion of the internal bore of the nozzle body downstream of the barrier that communicates with the first spray nozzle stage.

20. The spray nozzle assembly of claim 19, wherein the first fluid distribution passage communicates with the first portion of the internal bore of the nozzle body and a second portion of the internal bore of the nozzle body upstream of the internal bore communicates with the second spray nozzle stage.
